(19) United States
(12) Patent Application Publication
(10) Pub. No.: US 2015/0160798 A1
(43) Pub. Date: Jun. 11, 2015

(54) Multifunctional Operating Device for Motor Vehicles

(71) Applicant: Bayerische Motoren Werke Aktiengesellschaft, Muenchen (DE)

(72) Inventors: Hermann KUENZNER, Freising (DE); Marc HOFMANN, Muenchen (DE)

(21) Appl. No.: 14/565,209

(22) Filed: Dec. 9, 2014

Related U.S. Application Data
(63) Continuation of application No. 11/808,246, filed on Jun. 7, 2007.
Application No. 11/808,246 is a continuation of application No. PCT/EP2005/011221, filed on Oct. 19, 2005.

(30) Foreign Application Priority Data
Dec. 8, 2004 (DE) 10 2004 058 954.2

(51) Int. Cl. G06F 3/0482; G06F 3/0481

(52) U.S. Cl. CPC G06F 3/0482; G06F 3/04817

(57) ABSTRACT

A multifunctional operating device for a hierarchical menu structure consisting of several menus, includes a video screen, several operating keys, to which in each case one function within the menu structure can be assigned arbitrarily and can be selected by operating the respective operating key, and assigned visual information concerning the function selected by the operating key on the video screen. An operating status is assigned to the operating keys, in which operating status the assigned visual information concerning the selectable function is displayed on the video screen.

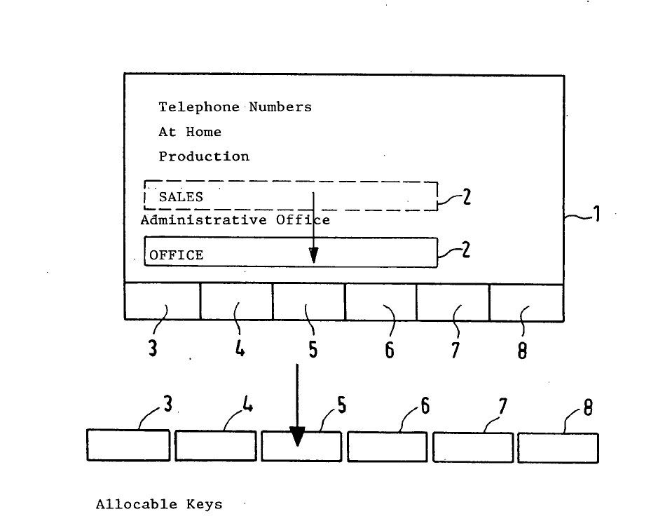

### CROSS-REFERENCE TO RELATED APPLICATIONS

This application is a continuation of application Ser. No. 11/808,246, filed Jun. 7, 2007, which is a continuation of PCT International Application No. PCT/EP2005/011221, filed on Oct. 19, 2005, which claims priority under 35 U.S.C. §119 to German Application No. DE 10 2004 058 954.2, filed Dec. 8, 2004, the entire disclosures of which are expressly incorporated by reference herein.

### BACKGROUND AND SUMMARY OF THE INVENTION

The invention relates to a multifunctional operating device for motor vehicles for a hierarchical menu structure consisting of several menus, including a video screen, several operating keys, to which in each case one function within the menu structure may be assigned arbitrarily and may be selected by operating the respective operating key, and assigned visual information concerning the function selected by the operating key on the video screen.

The term “function” as used herein may refer to a nodal point of the hierarchical menu structure, such as a menu itself, a pertaining submenu, or even one of the subordinate branches of the menu structure.

An operating device of the above-mentioned type is known from German Patent document DE 102 37 725 A. In DE '725 A, individual functions can be called by use of operating keys similarly to the stored stations in the case of radio station keys. As visual information, a labeling of the keys by use of the respective valid function is provided. For this purpose, the labeling can be displayed on the video screen in the proximity of these keys or on a display in the keys themselves.

A similar multifunctional operating device is known from European Patent document EP 0 701 926 B1, in which individual functions can be called by use of a common operating element. It is considered to be a problem in this case that, in view of the plurality of controls and additional equipment, which is to be operated by way of the single operating element, errors may occur in the selection and deflection due to environmental events. In European Patent document EP 0 701 926 B1, a solution to this problem is attempted in that a preselection of the respective menu takes place by use of individual menu keys and the “navigation within the selected menu”, that is, the finding and the selection of the function, takes place by use of the operating element. However, especially in the case of menus which have a plurality of additional functions, this does not represent any real help. If these menus are situated next to menus having only a few additional functions, this would lead to confusion, rather than represent any help.

It is an object of the invention to create a multifunctional operating device, which provides a fast and reliable access to the functions that can be called by use of the operating keys.

This, and other, objects are achieved by a multifunctional operation device for hierarchical menu structure which include several menus, has a display screen, several operating keys, to which in each case one function within the menu structure may be assigned arbitrarily and may be selected by operating the respective operating key, and has assigned visual information concerning the function selected by the operating key on the display screen. An operating status is assigned to the operating keys, in which the assigned visual information concerning the selectable function is displayed on the display screen. Advantageous embodiments and further developments are described herein.

In the case of the invention, a (first) information status is assigned to the programmable operating keys. Even before the respective function is selected, the user can, therefore, have an idea of the content of the function.

Depending on the implementation of the invention, the information status can be set in that the user touches the respective key, approaches it (with his finger for example), or briefly depresses it slightly.

In view of the plurality of functions which can be allocated to each key, the invention represents a clear help and improvement of comfort. The invention naturally also results in the avoidance of faulty operations.

A further improvement of the invention is obtained when, in addition to the above-mentioned information status, another (second) information status is provided which can be adjusted similarly to the first information status. In this second information status, more detailed information is then to be displayed on the video screen, while, in the first information status, brief information is to be displayed.

If the operating keys are constructed as touch keys, when the operating keys are touched for a short time, a short version of the assigned visual information is to be displayed on the video screen and, when the operating keys are touched for a longer time, a more detailed visual information concerning the function selected by the operating key is to be displayed on the video screen.

On the whole, for each of the operating keys, a differentiation can take place between up to four different usage possibilities.

When a “touching” takes place, visual information will be displayed. This information may be invariable or may vary as a function of the duration of the touch. As another possibility, the function is triggered preferably by pressing the key.

Finally, the key may also be programmed; that is, another function can be allocated to it. For this purpose, these keys can be operated in a manner known per se from German Patent document DE 102 37 725 A, which differs from the manner decisive for the selection of the function. One possibility consists of moving the key into its operative position for a predefined longer time period. Another possibility is obtained in that the key is rapidly operated several times successively.

A corresponding situation applies to the construction of the operating keys as first pressure switches or the assignment of proximity switches to the operating keys.

Other objects, advantages and novel features of the present invention will become apparent from the following detailed description of the invention when considered in conjunction with the accompanying drawings.

### BRIEF DESCRIPTION OF THE DRAWING

The single FIGURE illustrates a multifunctional operating device for motor vehicles according to the invention.

### DETAILED DESCRIPTION OF THE DRAWING

Referring to the drawing FIGURE, a finding and a selection takes place within a hierarchical menu structure by way of an operating element. The menu structure consists of several menus, such as an onboard computer menu, TV menu, audio menu, air conditioning menu (for details see, for example, German Patent document DE 197 52 056 A1). The operating element (not shown) is preferably a push-and-turn switch with an enter function, as is known from German Patent document DE 38 36 555 A1 (having U.S. Pat. No. 5,270,689, the specification of which is expressly incorporated by reference herein).

The respectively selected function is visually highlighted on a video or display screen 1. For this purpose, a cursor 2 is used, which highlights the selected function and which, corresponding to the movement of the operating element “travels” from function to function. Two positions are shown—an earlier position illustrated by a broken line, and the current position illustrated by a continuous line.

Several pushbutton (operating or control) keys 3 to 8 are arranged below the video screen 1. One function respectively from the different menus can be assigned to the pushbutton keys 3 to 8 by the user himself. This takes place in that the cursor is first moved to this function and thereby the function is set by use of the operating element (not necessarily selected). Here, the cursor is shown to be situated on the telephone number function which is assigned to the “office”. This telephone number, which is not shown as a concrete telephone number but only as a telephone number displayed on the basis of its importance, is displayed, together with the other stored and also only symbolically illustrated telephone numbers, on the video screen 1.

By applying pressure for a longer period of time on the key 5 (marked with an arrow for an illustration in the figure), the telephone number is placed from “office” to this key 5. When, in the future, this key is briefly pressed, the telephone connection setup to “office” takes place.

According to the invention, each of the keys 3 to 8 is touch sensitive.

Even before the key is pressed and the stored assigned function is activated, information (a short amount) concerning the assignment of the key appears on the video screen when a key, here, key 5 is touched. First the “office” information assigned to the key appears on the video screen. When the key is touched for a longer period of time, for example, longer than 2 seconds and is still not pressed, expanded information appears on the video screen; here the text “Dial Telephone Number Office 089/1234567”. When the key 5 is now pressed, as indicated above, the telephone connection is established at the indicated number.

The other keys can be allocated correspondingly and the thereby selectable function, in the event of a brief touch, as a short version, for example, BR3, and, in the event of a longer touch, as a more detailed version, here, for example, FM Station BAYERN 3, can be shown on the video screen 1.

As an alternative, a proximity switch with a (not shown) electronic analyzing system may also be assigned to the pushbutton keys 3-8, which, in the case of an approach at a distance of, for example, less than 15 mm, first displays a short information on the video screen, and, in the event of a longer stay at this distance, displays expanded information concerning the filed function on the video screen 1. As described above, the triggering of the function takes place by a brief pressing of the respective key.

Finally, a first pressure switch can also be assigned to each key. In the case of such a switch, short information is displayed at the first pressure. If then, within a time period of, for example, 1.5 seconds, no further input takes place (either a triggering of the function by another pressure or first pressure upon another switch), the detailed information is displayed. The triggering of the function takes place here by a more intensive brief depressing of the respective key. As described above, the storage of a function selected at the video screen 1 takes place by a more intensive and longer-lasting depressing of the respective key.

Even in the case of the increasing number of functions, an individual, fast and reliable selection of individual functions can be achieved in this manner.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A multifunctional operating device for a hierarchical menu structure composed of a plurality of menus, the device comprising:
a display;
a plurality of operating keys, one menu within the menu structure being arbitrarily allocable to a respective one of the plurality of operating keys, the one menu being selectable by operating the respective operating key;
assigned visual information related to the one menu selected by the respective operating key, the assigned visual information being provided on the display; and
wherein an operating status is assigned to the plurality of operating keys, in which operating status the assigned visual information relating to the selectable menu is displayed on the display.

2. The operating device according to claim 1, wherein the plurality of operating keys are touch-sensitive keys, and further wherein the operating status is set by touching the operating keys.

3. The operating device according to claim 1, wherein one proximity switch is respectively assigned to each of the plurality of operating keys, and further wherein the operating status is set when the one proximity switch detects an approach to a respective operating key.

4. The operating device according to claim 1, wherein, in each case, a first pressure switch is assigned to the plurality of operating keys, and further wherein the operating status is set upon a first-time pressing of the respective operating key.

5. The operating device according to claim 1, wherein a further operating status is assigned to the operating keys, in which further operating status an expanded amount of visual information concerning the selectable menu with respect to the assigned visual information for the operating status is displayed on the display.

6. The operating device according to claim 2, wherein, during a brief touching of an operating key, a short version of the assigned visual information and, during a longer touching of the operating key, a more detailed version of the assigned visual information is displayed on the display concerning the menu selectable by the operating key.

7. The operating device according to claim 5, wherein, during a brief touching of an operating key, a short version of the assigned visual information and, during a longer touching of the operating key, a more detailed version of the assigned visual information is displayed on the display concerning the menu selectable by the operating key.

8. The operating device according to claim 3, wherein, during a brief stay in a proximity of an operating key, a short version of the assigned visual information and, during a longer stay, a more detailed version of the assigned visual information concerning the menu selectable by the operating key is displayed on the display.

9. The operating device according to claim 5, wherein, during a brief stay in a proximity of an operating key, a short version of the assigned visual information and, during a longer stay, a more detailed version of the assigned visual information concerning the menu selectable by the operating key is displayed on the display.

10. The operating device according to claim 4, wherein, during a brief pressing of the operating key, a short version of the assigned visual information and, during a longer pressing, a more detailed version of the assigned visual information concerning the menu selectable by the operating key is displayed on the display.

11. The operating device according to claim 5, wherein, during a brief pressing of the operating key, a short version of the assigned visual information and, during a longer pressing, a more detailed version of the assigned visual information concerning the menu selectable by the operating key is displayed on the display.

12. The operating device according to claim 1, wherein the display is a video display.

13. A multi-function operating device for a hierarchical menu structure containing a plurality of menus, the operating device comprising:
a display;
a plurality of control keys, to which respectively one menu in the menu structure is arbitrarily allocable, said menu being selected when the respective control key is actuated; and
associated visual information relating to the menu selected by the control key;
wherein an operating status is associated with the control keys, in which operating status the associated visual information relating to the selectable menu is reproduced on the display.

14. A method of operating a multi-function operating device for a hierarchical menu structure containing several menus, the operating device including a display and a plurality of control keys, the method comprising the acts of:
arbitrarily allocating one menu within one or more of the several menus to a respective one of the plurality of control keys, by which the one menu is operable via the one respective control key;
assigning visual information concerning the one menu selectable by the one respective control key on the display; and
assigning an operating status to the plurality of control keys, in which operating status the assigned visual information concerning the one menu is displayed on the display.

15. The method according to claim 14, further comprising the act of assigning a second operating status to the plurality of control keys, in which second operating status expanded visual information with respect to the assigned visual information of the first operating status concerning the one menu is displayed on the display.
